(19) United States
(12) Patent Application Publication
(10) Pub. No.: US 2011/0081129 A1
(43) Pub. Date: Apr. 7, 2011

(54) BROADBAND RECORDING METHOD AND APPARATUS FOR VIDEO AND/OR AUDIO PROGRAMS

(75) Inventor: Ronald Quan, Cupertino, CA (US)

(73) Assignee: Rovi Technologies Corporation

(21) Appl. No.: 12/882,474

(22) Filed: Sep. 15, 2010

Related U.S. Application Data
(60) Provisional application No. 61/249,394, filed on Oct. 7, 2009.

(51) Int. Cl. H04N 9/80; H04N 5/76; H04N 5/92; H04N 5/93

(52) U.S. Cl. 386/252; 386/341; 386/337; 386/357; 386/E05.004; 386/E05.028; 386/E05.021; 386/E05.024

(57) ABSTRACT

A more efficient method of recording programs simultaneously is provided in one embodiment by translating certain bands of the RF spectrum and translating and or reordering the channel allocation into a (analog) spectrum of one or more lower intermediate frequency band(s). A recorder records the analog RF spectrum, which then is available for playback from the recorder. Programs contained in the played back RF spectrum are selectively extracted by means of a tuner and or demodulator for subsequent viewing, listening, or distribution. Alternatively, an RF signal is supplied to a recorder for recording or storage without translation. The recorder then plays back the RF signal to a tuner and or demodulator for display and or distribution.

### CROSS-REFERENCE TO RELATED APPLICATION

This application claims benefit of U.S. Provisional Ser. No. 61/249,394 filed Oct. 7, 2009, which is incorporated herein by reference in its entirety.

### BACKGROUND

The present invention pertains to video recorders or personal video recorders (PVRs) and more particularly to broadband recording and playback of bands of the RF spectrum.

Previous video recorders require a tuner/demodulator to record a video program. Ergo, to record multiple video programs, multiple tuners are coupled to an RF signal, wherein each tuner is set to a particular frequency or channel. The output of each tuner, which includes demodulation of each channel, is then coupled to a recorder for recording and subsequent playback.

In an advanced television system committee (ATSC) format, one channel may contain up to 4 to 15 sub channels, which then requires up to 4 to 15 tuners for demodulation of the sub channels contained in that the one ATSC channel. Thus, there is a need to more efficiently record video and or audio information, from for example, a digital television (DTV) stream.

### SUMMARY

Accordingly, the present invention provides various embodiments which circumvent the need for a multiplicity of tuners and demodulators when recording and playing back multiple video programs.

To this end, one embodiment records the broad spectrum of a television signal into a storage device. Upon playback, the storage device acts as a “delayed” broadcast RF signal such that the signal of any of the channels (including any sub channel) may be tuned and demodulated and viewed or distributed.

For example, a broad spectrum of television signals from 1 MHz to 19 MHz may represent three 6 MHz bandwidth digital television (DTV) channels (ATSC, SDTV, and HDTV channels). Depending on the compression ratio, up to 3 or 4 SDTV (sub digital television) channels fit into the 6 MHz channel space. Thus, three HDTV (high definition television) channels may be recorded simultaneously or up to 12 SDTV sub channels instead, or some combination of numbers of HDTV and SDTV channels or sub channels recorded simultaneously via recording the signal from 1 MHz to 19 MHz. In a simplest form, a single 6 MHz RF channel is recorded in the storage device to allow playback from the storage device to a tuner to extract multiple SDTV channels or sub channels, or some combination of SDTV channels and an HDTV channel. Note that channels or sub channels may include one or more audio and or video channels.

An alternative embodiment receives a broadband television signal and mixes or translates the multiple channels into a frequency range, which then is converted from an analog signal to a digital or discrete time signal for storage. The storage device is controlled by record commands and plays back a digital representation of the analog RF broadband signal. A digital to analog converter converts the output of the storage device to an analog RF signal, which then can be coupled to one or more tuners to view or distribute the one or more programs existing in the recorded RF signal.

One embodiment provides an alternative or improved method of recording audio and or video programming over the method such as disclosed, for example, in U.S. Pat. No. 7,454,120 (the '120 patent), herein incorporated by reference, where multiple tuners are used in recording more than one video program at a time. For example, an improved method of recording audio and or video programs (e.g., via a personal video recorder or PVR) includes one or more tuners/demodulators to record one or more programs at a time, but also includes a capability to record a broadband radio frequency signal. This improved method allows playing back a particular video program that has been demodulated and or playing back (e.g., via a tuner) a video program from the radio frequency domain.

Another embodiment also includes features disclosed in the PVR system of the '120 patent, and, in addition, includes processes which provide copy protection (e.g. negative going pulses, positive going pulses, and or a phase modulated signal within an overscan area of the television field) or digital rights management (DRM). For example, a PVR system including multiple tuners may include a content control signal that provides resistance to certain circumvention devices.

With major advances in low cost high speed analog to digital converters (ADC) and in low cost memory devices, another embodiment provides for recording a broadband, or one or more TV channel(s) or radio channel(s), by digitizing the RF domain signals. Prior to digitization, some form of frequency translation is done for one or more RF channels, which usually reside in the VHF or UHF spectrum. The frequency translation maps these channels to a lower frequency spectrum for more efficient analog to digital conversion and digital recording. It is to be understood that “translating” refers to operating in the frequency domain, to move frequency spectrums up or down in frequency.

Alternatively, since an analog to digital converter (ADC) utilizes a sampling frequency clock, the sampling frequency clock may be used as a method of digitizing an analog input signal and of providing one or more translated spectrums of the analog input signal. Sub-Nyquist sampling of signals provides a frequency translated spectrum of the input to an analog to digital converter. For example, if the (equivalent) sampling frequency of the analog to digital converter is less than twice the bandwidth or highest frequency of the input (RF) signal, then frequency translation is provided by the analog to digital converter, for example, in a form of alias signal(s). Thus, in an alternative embodiment, a radio frequency signal (e.g., ATSC or HDTV RF signal) may be coupled to an analog to digital converter, with or without a translation element or module prior to the input of the analog to digital converter.

In another embodiment, one or more ATSC channel and or radio channel is translated to a lower frequency spectrum. An analog to digital converter (ADC) converts the lower frequency analog signal RF into a digital signal for subsequent storage. It should be noted that after digitization from the ADC, coding or compression techniques and or transformations may be applied to save on storage space. Upon playback from the storage device, which may include decoding or decompression schemes or transformations, a digital to analog converter reproduces an RF signal. A tuner then is utilized to provide multiple program signals from the recorded ATSC channel(s).

In yet another embodiment, an RF signal is supplied to a recorder to store or record the RF signal. The recorder then plays back a recording of the RF signal to a tuner and or demodulator for subsequent display and or signal distribution. Thus, it is to be understood that translation functions or circuits, intermediate frequency (IF) systems, and or mixers may be optional, such that an RF signal is coupled to a recorder without frequency translation and or intermediate frequency circuits or systems. An example of such a RF signal is a signal including video, text, and or audio information. Another example of such a RF signal is a signal which includes an FM (frequency modulated), PM (phase modulated), and or AM (amplitude modulated) signal. Other examples of the RF signal include a DTV signal, an analog RF television signal, an HDTV RF signal, a modulated signal, a sub channel video, a WiFi signal, a WiMax signal, an Internet signal, a wireless network signal, a LAN (local area network) signal, an 802.11 signal, an Ethernet signal, a Mobile (analog and or digital) TV signal, a Handheld (analog or digital) TV signal, a sub channel audio, video channel, audio channel, and or data signal/channel. Any of the RF signals may be coupled to a recorder (with or without a frequency translation circuit/system and or an intermediate frequency system) for recording in the RF domain. Any of the recorded signals may then be coupled to a demodulator or tuner for providing one or more video, audio, and data signal/channel.

An embodiment may include the ability to record one or more channels from the RF domain of a transmitted signal (e.g., off the air such as a television/radio signal), a cable television/radio signal, a satellite television/radio signal, an Internet, WiFi, Wimax, cell phone RF signal, and or the like. Further, an embodiment includes playing back a recorded signal from the RF domain such as, for example, play back of a recorded signal including vestigial sideband, phase/amplitude modulated, quadrature modulated, and or frequency modulated signal, and coupling (via playback) the recorded (RF) signal to a tuner/demodulator to provide a signal for displaying/viewing (video) and or listening (audio). One or more tuners and or demodulators may be coupled to the playback of the recorded RF signal to provide one or more selection (or simultaneous selection) of (demodulated) video, data, metadata, and or audio signals.

In yet another embodiment, an optical signal may be coupled to a recorder for recording in optical format as an optical signal (e.g., modulated waveform). An output of the recorder may include an optical and or electrical output for display, transmission, and or distribution.

In still another embodiment, during or prior to recording, one or more ATSC channels, RF channels, or radio channels may be sensed, for example, via a tuner, for use as metadata. This metadata, such as programming schedules or guides, or information, may be stored or displayed to assist a user. Alternatively, the recorder may be coupled to WiFi, WiMax, digital network, IPTV, or linked to a Web (e.g., World Wide Web), which downloads and/or displays pertinent information of the program audio or video selections, or provides content or program material. Thus, an embodiment may include a tuner for a broadcast system and or a tuner for a wireless network.

### BRIEF DESCRIPTION OF THE FIGURES

FIGS. 1A and 1B are block diagrams exemplifying prior art recording devices.

FIGS. 2A and 2B are block diagrams illustrating embodiments of the invention.

FIG. 2C illustrates another embodiment.

FIGS. 3A and 3B are waveforms showing examples of frequency translation or mixing.

FIG. 4 is a block diagram illustrating another embodiment of the invention.

FIG. 5 illustrates another example of frequency translation.

FIG. 6 is a block diagram illustrating embodiments including a content control signal and or a copy protection signal.

### DETAILED DESCRIPTION

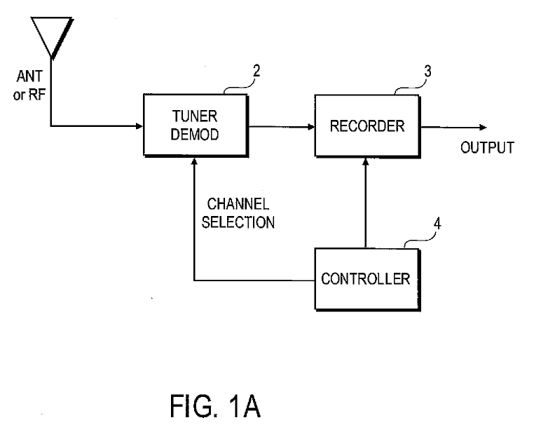

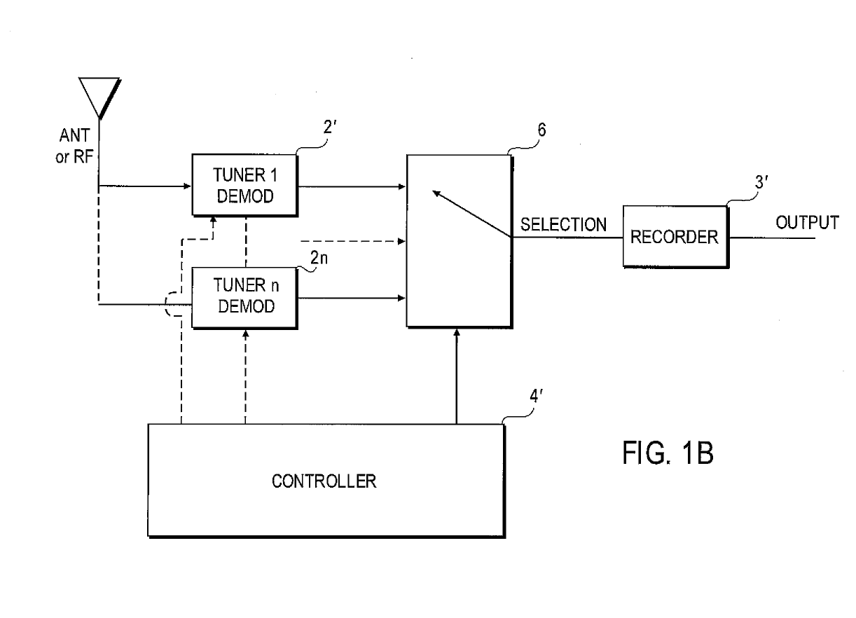

FIG. 1A illustrates a conventional recorder, where an antenna or RF signal (source) is coupled to a tuner-demodulator 2. The tuner-demodulator receives analog and or digital signal transmissions, such as PAL or NTSC video signals for analog systems, or DTV or ATSC signals for digital systems.

The tuner-demodulator 2 in analog systems may comprise an AM detector. The output of the AM detector is an analog signal, which in turn is coupled to a recorder 3, which may include an analog to digital converter to enable digitally recording the analog video signal.

For a digital signal, demodulation is provided by an 8VSB (vestigial sideband modulation) or QAM (quadrature amplifier modulation) detector. The detector output of the 8VSB or QAM demodulated signal is in the form of a transport stream, which requires decompression from formats such as MPEG-1,2, or 4, Divx, Windows Media, RealNetworks, DB-25, H.264, DCT or wavelet coding, or the like.

A controller 4 is provided to set the channel for the tuner-demodulator 2, and or to set the recording times or intervals for recorder 3.

FIG. 1B illustrates an alternative though similar recording system as that in FIG. 1A, and includes multiple tuner-demodulators 2′ through 2n to allow for recording and or viewing multiple channels via the demodulated 8VSB or QAM signals. Here the RF signal is coupled via an antenna or other connection to the tuner-demodulators 2′ through 2n. A selection switch 6 is coupled to the tuner-demodulators 2′ through 2n. It should be noted that switch 6 can switch in more than one source at a time, which allows a recorder 3′ to record one or more transport streams from the demodulated 8VSB or QAM signals. Controller 4′ allows channels to be set on the tuner-demodulators and or allows the switching of one or a combination of channels from respective tuner-demodulator(s) to be coupled into the recorder 3′.

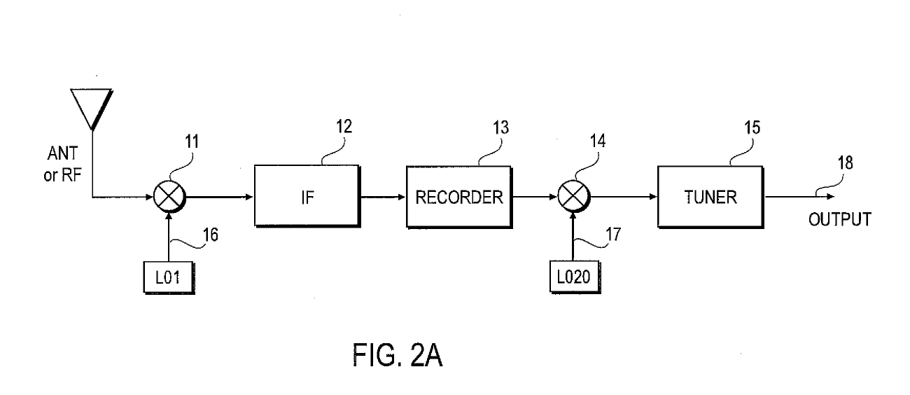

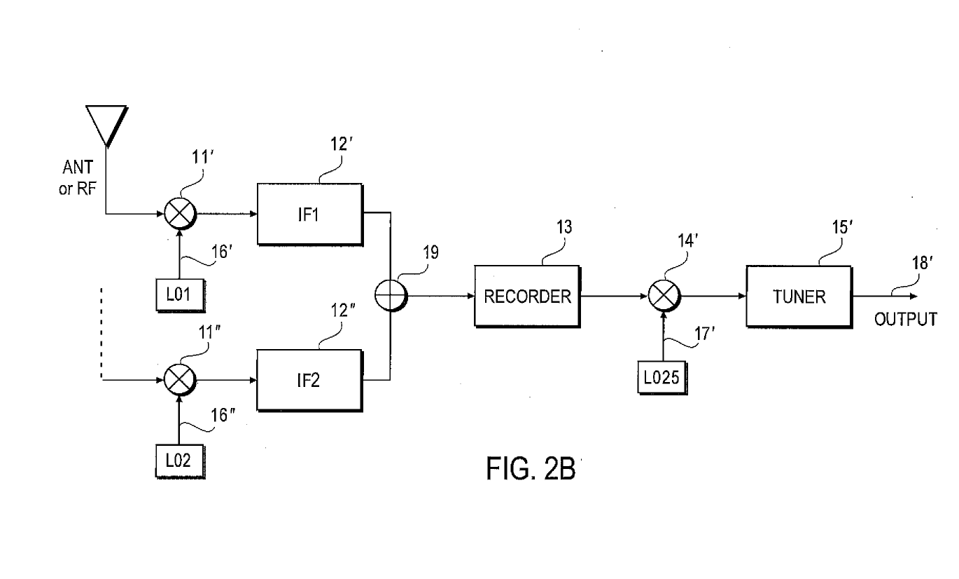

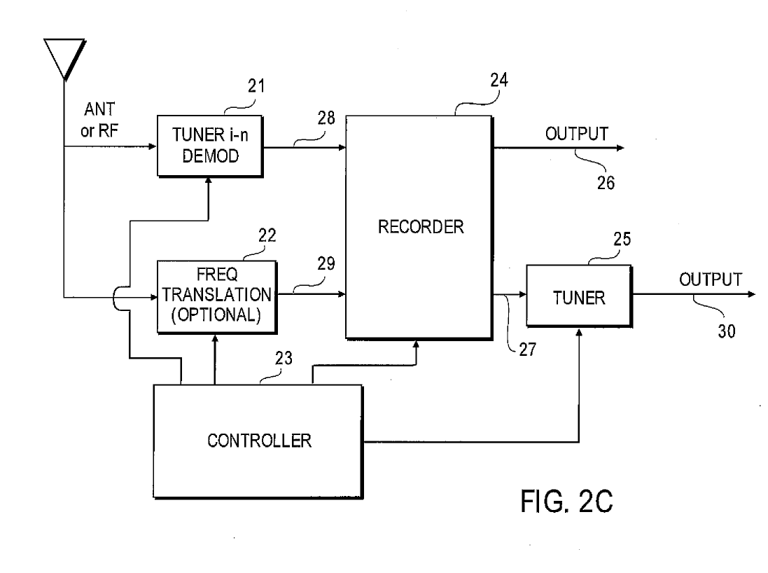

FIG. 2A is a block diagram illustrating an embodiment wherein an RF signal from an antenna is coupled to a first input of a mixer 11, while a second input of mixer 11 is coupled to a local oscillator (LO1) via an input 16. The output of the mixer 11 is coupled to an intermediate frequency (IF) amplifier/filter 12, which provides a frequency translated RF spectrum to a recorder 13. For example, an ATSC channel at a UHF frequency beyond 490 MHz, is mixed down via the mixer 11 to a lower frequency (e.g., less than 10 MHz), or to an intermediate frequency (IF) analog signal, which allows easier analog to digital conversion in the recorder 13.

With recorder 13 recording the RF spectrum such as VSB or QAM signals, playback of the recorded RF spectrum provides VSB or QAM signal(s). The output of recorder 13 is coupled to a tuner 15 via an optional mixer 14. A second input of mixer 14 is coupled to a local oscillator (LO20) via an input 17. Mixer 14, for example, converts or translates the IF signal, for example, from recorder 13 (or amplifier/filter 12) back to an RF channel frequency. It follows that a tuner 15 can demodulate the multiple channels within the RF channel that is selected. It is given that the multiple channels within the RF spectrum were recorded simultaneously. As an example, some ATSC channels include a high definition (HD) channel and one or more sub channels that may include standard definition video and or audio sub channels, while a digital television (DTV) channel may include any combination of HD, SD, and audio channels. Thus by recording substantially the (single) selected RF channel, multiple video and or audio programs may be combined, recorded and then individually or selectively demodulated or recovered.

FIG. 2B is a block diagram illustrating another embodiment for recording multiple RF channels, to provide further channels from different RF channels along with the one or multiple channels demodulated in each RF channel recorded. An antenna or RF signal (source) is coupled to one or several mixers, herein illustrated by mixers 11′ and or 11″. A local oscillator (LO1) provides an input 16′ to the mixer 11′. The local oscillator LO1 is set at a frequency (FLO1) such that the mixer 11′ outputs a frequency spectrum IF1. Similarly, a local oscillator (LO2) provides an input 16″ to the mixer 11″. The local oscillator LO2 is set at a frequency (FLO2) such that the mixer 11″ outputs a frequency spectrum IFn. The outputs of mixers 11′ and 11″ are supplied to IF amplifiers or filters 12′ through 12′n, respectively.

The outputs of the amplifiers or filters 12′ and 12′n (of frequency spectrums IF1 and IFn) now contain a signal RF spectrum for two or more RF channels. A combining circuit 19 sums the two RF signals IF1 and IFn from amplifier/filters 12′ and 12′n and couples its output to a recorder 13. The recorder 13 records an analog signal containing two or more RF channels. Upon playback, the recorder 13 is coupled to a tuner 15′ via a mixer 14′, wherein the tuner 15′ selects the RF channel related to the frequency spectrums IF1 and or IFn. Note that tuner 15′ may include multiple tuners (and or demodulators) to tune each channel related to signals IF1 and or IFn. The mixer 14′ is coupled to a local oscillator (LO25) at an input 17′ to the mixer 14′. The mixer 14′ may be used to translate the recorded and played back IF1 and or IFn frequency spectrums to channel allocations typically in the VHF or UHF spectrum. The output of the tuner 15′ has an output 18′, which provides the multiple (program) channels demodulated for each RF channel recorded.

Although in a simplest form, the mixer 14′ may translate both the spectrums IF1 and IFn via the local oscillator (LO25), it is possible to translate each spectrum IF1 and or IFn to a specified or determined channel frequency by using two mixers and two local oscillator frequencies. It is understood that although FIG. 2B shows an example of two RF channels, N number of channels may be scaled accordingly to record N RF channels. It should be noted in general, an intermediate frequency, IFx=p(Frequency of RF source)+/−q(Frequency of LO, a local oscillator), where x, p, and q are integers.

FIG. 2C shows an embodiment including a RF signal recording and or demodulated RF signal recording. An antenna (ANT) or RF signal source is coupled to one or more inputs of one or more tuner-demodulators 21. One or more outputs 28 of the one or more tuner-demodulators is coupled to a recorder 24. The antenna or RF signal source also is coupled to an input of an optional frequency translation module 22, which is implemented by a function and or a circuit. An output of the frequency translation module 22 is coupled via an input 29 to the recorder 24. Note that the frequency translation module 22 may be bypassed whereby the antenna or RF signal is coupled to the recorder 24. Controller 23 configures one or more demodulated channels to be recorded and or one or more RF signals, spectrums or bands to be recorded. An output 26 of recorder 24 comprises a playback signal of one or more demodulated television channel Recorder 24 may playback an RF signal 27, which is coupled to an input of a tuner 25. An output of tuner 25 provides (via controller 23) a selection of playback of one or more channels and or one or more sub channels. The sub channels may include flexibility to select a secondary audio program (SAP) and or an auxiliary audio/video channel, or access to metadata or programming guides. For example, output 26 provides a “main” channel viewing, while (simultaneously) an output 30 provides “surfing” on the recorded RF channel(s) and or sub channels.

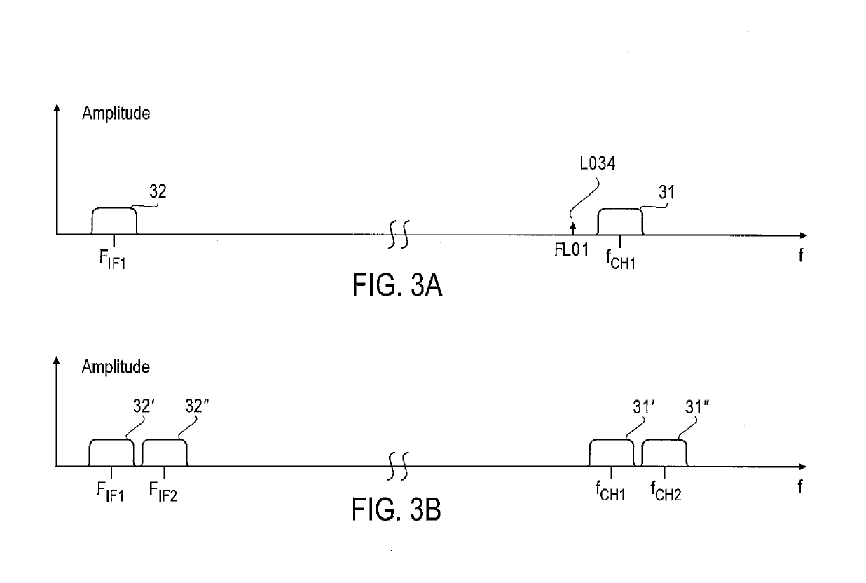

FIG. 3A illustrates an embodiment of RF spectrum translation. As previously mentioned, one or more RF channel is translated down and recorded via an ADC in a storage medium. (See FIGS. 2A and 2B). In this example frequency fCH1, (waveform 31), represents a typical RF channel in the VHF, UHF, or higher frequency spectrum. For ATSC, this RF channel is about 6 MHz wide, and includes a main program channel plus one or more sub program channels (e.g., a weather channel, a traffic channel, alternate SDTV programming, audio programming such as radio, etc.), plus metadata and or a programming guide(s). A local oscillator LO34 at a frequency FLO1 is set lower (or higher) than the frequency of fCH1 to mix down to a lower frequency FIF1, (waveform 32). For example, the difference frequency provided by a nonlinear element, function or mixer, takes the two higher frequencies fCH1 and FLO1 and provides a lower frequency, absolute value |fCHI−FLO1| for the frequency spectrum FIF1.

In some embodiments, the translated channel FIF1, which as previously mentioned includes a main program channel plus one or more sub program channels, such as a weather channel, a traffic channel, time code, alternate SDTV programming, audio programming such as radio, etc., is converted from an analog RF signal to a digital signal. The digital signal then can be stored in a medium, such as, for example, tape, magnetic disc, optical disc, RAM, ROM, flash memory, electromechanical storage, and or solid state storage device(s).

FIG. 3B illustrates another embodiment wherein more than one RF channel is recorded by frequency translation. For example, RF channels fCH1 (spectrum 31′) and fCH2 (spectrum 31″) are mixed down in frequency by oscillator frequencies FLO1 and FLO2, respectively (not shown), to provide lower frequency RF channels FIF1 (spectrum 32′) and FIF2 (spectrum 32″). These two (or more) lower frequency RF signals are then digitized via an ADC and coupled to a (digital) storage device for recording. Again, frequency spectrums FIF1 and or FIF2 still retain a program video channel, time code, audio, sub-video-channel(s), radio channel(s), metadata, and or programming guide (information).

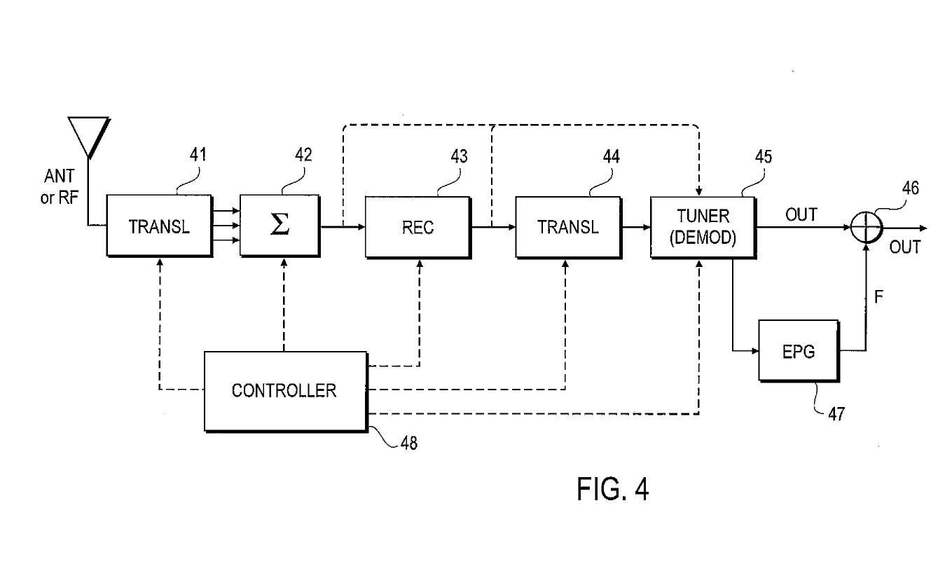

FIG. 4 is a block diagram illustrating another embodiment. An RF signal or signal from an antenna or link (e.g., an optical, phone, cable, satellite, wireless link, etc.) is coupled to a frequency translator 41. The translator 41 outputs one or more frequency translated RF channels to a summer/combiner 42, whose output is then one or more down-converted RF channel, which is coupled to a recorder 43. Recorder 43 typically includes an analog to digital converter to digitize the down-converted RF channel(s) for recording into a digital storage media.

The output of the recorder 43 includes a digital to analog converter (DAC) which outputs one or more frequency translated RF analog signal(s) for one or more channel(s). The output of recorder 43 may be coupled directly to a tuner 45, or may be coupled to the tuner 45 via a frequency translator 44. If the tuner is capable of receiving lower frequency signals, the translator 44 may not be necessary. If the tuner 45 is set for a standard broadcast tuning or higher frequency tuning (e.g., higher than an IF frequency) translator 44 is used in up-converting or translating the IF signal(s) to channels in the VHF, UHF, or higher, frequencies.

The tuner 45 may be coupled to an electronic programming guide (EPG) 47 or to a programming guide device or reader, which extracts metadata and or programming guide information from the tuner 45. A summing device or circuit, summer 46 then provides program video from tuner 45 and or programming guide information from EPG 47, at the output of the summer 46.

A controller 48 provides control signals to translator 41 for translating selected RF channels and to summer/combiner 42 for summing or combining selected IF frequency channels. Controller 48 also may send a command to recorder 43 for recording times, input signals selection, etc. Upon playback, controller 48 allows tuner 45 to select one or more recorded RF channels or subchannels for viewing or for distribution.

It should be understood that the embodiments of FIGS. 2A, 2B, 2C and 4 may be combined with the features or circuits previously mentioned and shown for example in FIG. 1A or 1B. Or in general, any embodiment may include frequency translation to a higher and or lower frequency (e.g., up conversion [translation] and or down conversion [translation]).

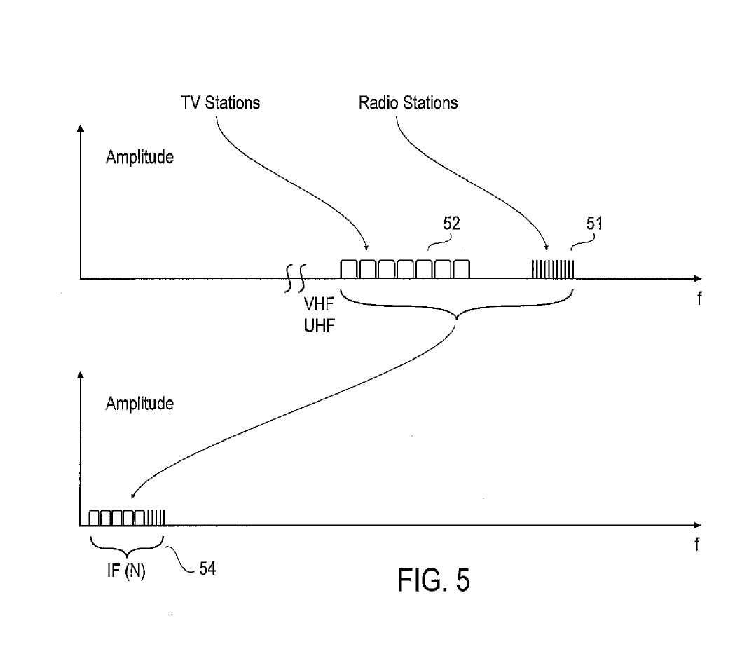

FIG. 5 illustrates an embodiment wherein television channels 52 and or radio channels 51, which are generally above the VHF band (e.g., >30 MHz), are translated down to IF(N) frequencies 54. One or more channel in the IF(N) frequency range then is digitized for recording. In this example, any number of television and or radio channels from channel 52 and or channel 51 may be chosen and then “mapped” via frequency translation to a lower frequency.

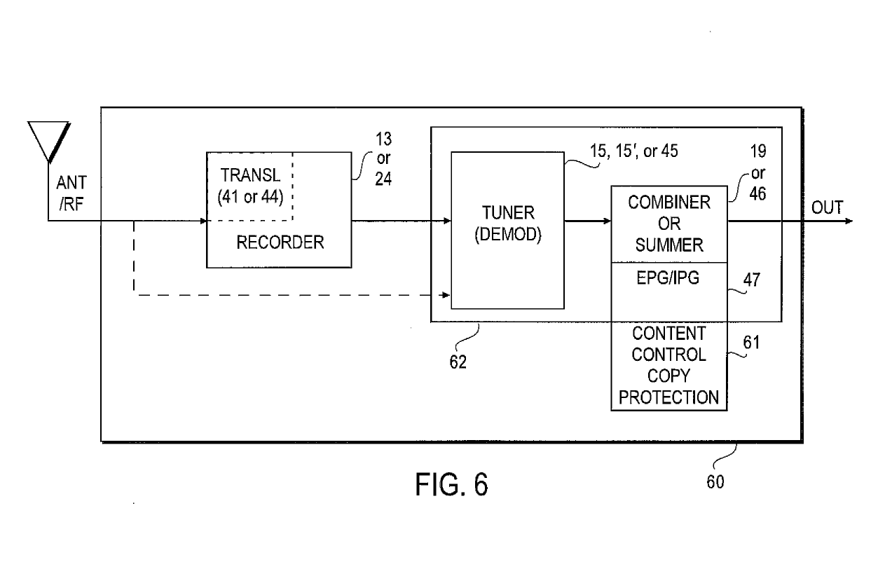

In FIG. 6, a tuner or recorder such as the recorder 13 or the recorder 24 discussed above may include electronic programming guides and or interactive programming guides (indicated by the block 47 within block 62), such as described in the U.S. Pat. No. 6,665,869 (the '869 patent), incorporated by reference. A tuner or recorder may be linked to a digital network or to another tuner/recorder such as described in the '120 patent. For instance, one or more of the tuner 15, tuner 15′, tuner-demodulator 45, electronic program guide 47, and or the summer 46 described above may be implemented in conjunction with the tuner/epg/combiner 62 and or the content control block 61 of FIG. 6 to provide at an output terminal that includes a program video signal, a programming guide, and or a content control/copy protection signal. As illustrated in FIG. 6, an example embodiment of a system 60 is shown. An antenna or RF signal is coupled to a recorder such as shown as block 13 or 24 in previous figures. In this example, the recorder 13 or 24 may include optionally a translation module 41 and or 44 of the previous figures, which may be implemented by a function or a circuit, and which then optionally translates in frequency a portion of the RF spectrum from the antenna or RF signal. The output of the recorder 13 or 24 is then a recorded RF signal, which is coupled to a block 62. Block 62 includes a tuner such as the tuner 15, 15′, or 45 of the previous figures. The tuner 15, 15′, or 45 may receive a signal from an output of the recorder 13 or 24, or receive a signal from the antenna or RF signal (as shown in dashed line). An output of the tuner (15, 15′, or 45) is coupled to an input of a combiner/summer circuit such as the combining circuit 19 (FIG. 2B) or the summer 46. The combiner/summer (19 or 46) may be coupled to an electronic program guide (EPG) 47 or interactive program guide (IPG), and or to a content control/copy protection signal source 61. Thus, for example, an output terminal of the combiner/summer (19 or 46) may include a programming guide signal for viewing a set of one or more programs that is available or scheduled, and or a content control or copy protection signal to provide content control or copy protection of one or more video programs. For example, a programming guide from block 47 can provide a pattern of cells, which contains a list of times and or dates for movies or television programs. In terms of content control or copy protection, one or more bits from an output of the recorder (13 or 24) or the tuner (15, 15′, or 45) may be utilized to enable/disable or to program a content control and or copy protection signal for block 61.

U.S. Pat. No. 5,479,268 (the '268 patent) and US Patent Publication No. 2003/0149980 (the '980 publication), pertain to programming guides such as EPG (Electronic Programming Guide) and IPG (Interactive Programming Guide), and are both incorporated by reference herein in their entireties. An exemplary programming guide, which may be provided or derived via an IPG or EPG signal, is for example a method or apparatus allowing a user to select one or more (favorite) video channel(s). The guide includes providing to a display, e.g., via a screen, a number of cells representing a corresponding number of video channels available for viewing by a user, where each cell includes a channel number and/or a program service name for a particular channel. The user uses the display to select a channel among the number of channels; for example, changing a status of the selected channel to that of a favorite channel in response to the user selection, or displaying in cells corresponding to the favorite channels a visual indication that the selected channels are favorite channels, and providing program guide information for the subset of channels having said favorite status in response to the user's indication to view the program guide information.

Another example of a programming guide (for the block 62 of FIG. 6) includes a method or apparatus for navigating about a television or video listing including one or more steps of: storing in electronic or computer readable memory a number of television or video program listings, each listing including title, telecast time, and/or channel; displaying on a monitor screen some of the titles of the program listings in a grid format of time and channel; moving a cursor on the screen to mark one or more of the displayed titles in the grid guide format; opening to the marked title in a single or multiple format, which may instead be of the (original) grid guide format, where the single channel format includes rows (or columns) of sequential television or video program listings for the channel corresponding to the marked title; additionally including moving the cursor on the screen to mark a different displayed title in the single channel format; where the storing step stores programming listings and/or the displaying step displays simultaneously, with the program listings, the program notes corresponding to the marked title.

Such a grid pattern or cell may include straight or curved segments. Alternatively, a two dimensional grid pattern may be transformed to a three dimensional grid pattern or vice versa. Such a grid pattern may include three and/or two dimensional properties. For example, one cell to another cell in the programming guide may be represented in a curved surface and/or a solid object's sides. Cells may be of regular and/or irregular shape(s).

As shown in relation to block 61 of FIG. 6, an output of any of the embodiments of previous description, may include content control signals (data, CGMS, flag signals) and or at least part of a copy protection signal such as modified color burst envelope, automatic gain control (AGC) pulses, pseudo sync pulses, narrowed horizontal syncs, incorrect phase or frequency in terms of color sub carrier frequency provided in a horizontal blanking interval or its vicinity, level shifted portion of a video signal, and or modified sync or AGC pulses in amplitude, position, and or duration.

The following patents pertaining to copy protection, content control, or flag signals are incorporated by reference: U.S. Pat. Nos. 4,631,603 (signal including pseudo sync and or AGC pulses); 4,819,098 (signal including AGC back porch pulses and or horizontal sync amplitude modification/modulation); 4,577,216 (signal including phase modulated color burst); 5,130,810 (signal including back porch pulse, positive and or negative); 5,315,448 (control bit pattern for adding/inserting content control signal); 4,937,679 (detection of negative and or positive going pulses for content control); 4,907,093 (detection of negative and or positive going pulses for disabling or modifying recording); 5,583,936 (lowered back porch signal); 6,381,747 (providing content control via a control bit(s) from a digital delivery system to a receiver wherein the receiver provides a content control signal at its output); 6,836,132 (color stripe or split burst color stripe signal for content control); 6,836,549 (position and or pulse width modulation of negative and or positive pulses that are utilized for a content control system); 7,039,294 (color burst modification for content control); 7,050,698 (lowered front and or back porch with color burst modification); 7,085,380 (adding/inserting a negative going pulse to a video signal as part of a content control signal); 6,501,842 (adding a negative going pulse in a back porch region as part of a content control signal for a video signal); 7,492,896 (lowered back porch in a video signal); 6,600,873 (detection of phase modulated color burst such as color stripe or split burst color stripe signal for content control).

Thus, an output of any embodiment of previous description may include a weakened color stripe signal, and or a copy protection signal, that provides resistance to a circumvention device, generally known in the industry as a “black box.” A weakened color stripe signal is generally used for content control while providing excellent playability of the copy protected video signal on a television set.

For example the provision of one or more pseudo sync pulses (for a set or series of television lines) in a television line immediately, or one line delayed, after the last television line containing a post equalizing pulse, causes a circumvention device to pass at the circumvention device's output, an effective and or enhanced copy protection or content control signal.

The following patent applications which were filed in 2009 to Ronald Quan, or Ronald Quan and John Cloutman, are related to weakened color stripe signals and or signals providing resistance to certain circumvention devices, and are incorporated by reference: 2010/0054469; 2010/0171880; 12/563,050; and 2010/0054700.

Thus, alternative embodiments include a content control, or type RP signal, where R refers to resistance and P refers to playability. Ergo, RP equals resistance to a circumvention device or provides improved playability, or weakened color stripe protection signal from an integrated circuit that improves geometric distortion for better playability, a content or type RP or weakened color stripe protection signal that reduces or defeats the function of a circumvention device, and/or a content or type RP or weakened color stripe protection signal from an integrated circuit that triggers or causes a circumvention device to enhance copy protection effect(s). Such content or type RP or weakened color stripe protection signals may be utilized in an integrated circuit including a digital to analog converter coupled to a source of digitally recorded material or digital video for providing a baseband video signal from a digital signal, a signal sensing or reader circuit for detecting or reading a copy protection bit, a bit pattern or content control bit(s), and a signal generator for generating a content or type RP or weakened color stripe protection signal at the output of the digital to analog converter in response to the copy protection bit, bit pattern, or content control bit(s).

Further embodiments of the invention include any of the following. A method where the copy protection signal is supplied via an output of the integrated circuit to an input of the circumvention device, where the output of the circumvention device passes at least part of the protection signal sufficiently for a protection or content control effect, and/or where the output of the circumvention device provides a signal to further distort or blank a portion of an active television field. A method where the protected video signal from the integrated circuit is coupled to an input of the circumvention device, where the output of the circumvention device supplies a signal that is substantially effective in terms of copy protection or content control for a video recorder or for a content control system. A circuit for inserting or adding, in at least one television line, one or more pseudo synchronization pulses or one or more pseudo synchronization pulse or AGC pulse pair signals immediately after or less than two or two and a half lines after a vertical synchronization signal or post equalizing pulse (e.g., in an odd field, even field, or both fields) to, for example, provide resistance to a circumvention or black box device.

Another embodiment includes a method of providing a different number of pseudo synchronization pulses from one video line to another video line and/or different pseudo synchronization pulse widths from one video line to another, generating at least two lines consecutively with substantially the same number of pseudo synchronization pulses and/or substantially the same pseudo synchronization pulse width, e.g., for improved signal playability.

In another embodiment a content or type RP signal, or weakened color stripe protected video signal, is supplied to a television set via an output of a receiving device, wherein improved playability is achieved e.g., via reduced “hooking” on a top portion of the television e.g., by shifting the pseudo synchronization line locations closer to the vertical synchronization signal, or by reducing pseudo synchronization pulse(s) near the beginning of the active field, or by providing two or more consecutive television lines with the same or substantially the same number of pseudo synchronization pulses if the number of pseudo synchronization pulses alternates from line to line.

Another embodiment includes a method of starting or providing pseudo synchronization pulses immediately after or less than two or two and a half lines after a vertical synchronization signal or post equalizing pulse, to provide the content or type RP protection signal at an output of the integrated circuit, and may include one or more of the following: a color burst modification of whole or segmented portions of one or more color burst envelope which includes one or more cycle of incorrect color burst, a weakened color stripe signal, level shifting of a portion of the video signal including lowering or raising one or more portions of the video signal, modifying synchronization location, amplitude, and/or pulse width in selected video lines, providing back porch pulses of different video levels from one video line to another, providing pseudo synchronization and/or AGC pulses of different pulse widths from one video line to another, providing pseudo synchronization and/or AGC pulses of different numbers from one video line to another.

The protection signal is supplied via an output of the integrated circuit receiver to an input of the circumvention device, wherein the output of the circumvention device passes at least part of the protection signal sufficiently for a copy protection or content control effect, and/or wherein the output of the circumvention device provides a signal to further distort or blank a portion of an active television field.

Copy protection is provided by combining pseudo synchronization and/or pseudo synchronization and automatic gain control (AGC) pulses immediately after a vertical synchronization signal, or less than two or two and a half video lines after a vertical synchronization signal or post equalizing pulse, with the color burst modification, e.g. color stripe, partial color stripe, weakened color stripe. The combination signal is generated at an output of the integrated circuit, where the color burst modification includes cycles of incorrect phase or frequency in selected video lines, wherein the baseband, composite, and/or component output of the integrated circuit is coupled to an input of the circumvention device, and wherein outputting a content or type RP or weakened color stripe protection signal via the circumvention device unintentionally produces color distortions in the modified color burst of the copy protection signal and extra color distortion due to blanking or modifying of color burst envelopes in an active video field. Thus, copy protection is caused by the circumvention device, contrary to its intended purpose.

A type RP signal includes negative going pulses or pseudo sync pulses (e.g., one or more (negative) pulses per line) in one or more lines within two lines (e.g. <2 lines) of the last television line having post equalizing pulses for the vertical sync signal. In a standard pseudo sync process, the pseudo sync pulses occur two lines or more after the post equalizing pulses. Thus, there are two lines that are normally blanked or that normally have no negative going pulses after the last post equalizing pulse. Certain circumvention devices detect the lack of negative pulses for the one or two lines after the post equalizing pulses, to identify the start of the pseudo sync pulses in the vertical blanking interval. Once the start point is identified by these circumvention devices, the standard pseudo sync process is deleted by signal modification circuits in the circumvention devices. For example, in a 525 line system the last post equalizing pulse lines are at lines 9 and 271. And in a 625 line system the last post equalizing lines are at lines 5 and 317. A standard 625 pseudo sync pulse signal may start with pseudo sync pulses at lines 8 and 320, which is deleted by certain circumvention devices (black boxes). It was found experimentally, by providing/including one or more pseudo sync pulses in lines 6, 7, 318, and or 319 for a 625 line format (for a first type of RP signal), these certain circumvention devices did not sufficiently remove the pseudo sync pulses, and or the associated AGC pulses. Similarly in a 525 line format, providing/including one or more pseudo sync pulses in lines 10, 11, 272, and or 273 (for a second type of RP signal) caused certain circumvention devices to fail in sufficiently removing pseudo sync pulses, and or the associated AGC pulses. In at least one 525 line format circumvention device, providing a pseudo sync pulse(s) or negative going pulse(s) immediately after the last line of post equalization pulses (or end or vertical sync signal) causes this particular 525 line format circumvention device to fail. For example, a circumvention device failure in general includes passing, via its output content control/copy protection pulse(s)/signal(s) and or removing/attenuating (at least) a portion of the active field, or color burst signal. A portion of the active field may include one or more portions of one or more lines outside the vertical blanking interval.

An input to, for example a PVR or device with one or more embodiments, may include a video signal with a standard protection signal that is not resistant to a black box, wherein an output video signal from the device including one or more embodiments, provides a new protection signal resistant to circumvention devices and/or a new protection signal with improved playability. Further, an input to a device with one or more embodiments, may include a video signal with a content or type RP protection signal that is resistant to a black box (e.g., a black box or circumvention device that fails to sufficiently remove pseudo sync pulses and or associated AGC pulses for circumventing content control or copy protection), with an output video signal providing a protection signal not resistant to black boxes, and/or a new protection signal with improved playability. One or more type RP protection signal is described in U.S. patent application Ser. No. 12/711,834, Method and Apparatus for Receiving Metadata, EPG, or IPG Signals in an Integrated Circuit for Control Purposes to a Recorder, which is incorporated by reference.

A phase modulated color burst signal may be included in any embodiments of previous description. For example, a color burst that has one or more cycles of non standard phase (e.g., 20 degrees to 180 degrees from a reference color burst phase) may be included. A split burst signal comprising multiple cycles of normal and or non normal phase for one or more lines within a television field or frame is an example signal that may be included in an output of any devices that include broad band recording.

A weakened color stripe or phase modulated signal may include (within 15%) 2 cycles of normal color subcarrier phase, 6.5 cycles of non normal color subcarrier phase (e.g., 180 degrees), and or 7 cycles of normal color subcarrier phase. Alternatively, another weakened color stripe or phase modulated signal may include (within 15%) 6.5 cycles of non normal color subcarrier phase (e.g., 180 degrees), and or 8.5 cycles of normal color subcarrier phase. The weakened color stripe signal may occur in R lines per Q lines, where R and Q are from the set of integers. For example, a weaken color stripe signal may be provided in a 1, 2, 3, 4, or 5 line(s) per Q lines, where Q is greater than 1, 2, 3, 4, or 5 (and where Q is greater than R). A television color standard may be in PAL or NTSC (or a variant signal, such as a progressive or interlaced signal with color subcarrier), or in a composite, S-Video, or Y/C television signal.

This disclosure is illustrative and not limiting. Further modifications will be apparent to those skilled in the art in light of this disclosure and are intended to fall within the scope of the appended claims.

What is claimed is:

1. A method of recording and subsequently playing back one or multiple RF signals containing one or more programs, comprising:
recording the one or multiple RF signals;
playing back the recorded one or more multiple RF signals; and
selectively tuning and demodulating the one or more multiple RF signals via one or more tuner-demodulator to view or distribute the one or more programs contained in the one or multiple RF signals.

2. The method of claim 1 further comprising:
down-translating the one or multiple RF signals to a lower frequency spectrum prior to recording; and
upon playback, up-translating the lower frequency spectrum back to one or more multiple RF signals prior to selectively tuning and demodulating.

3. The method of claim 1 wherein the RF signals comprise one or more video and or audio channels including descriptive video services (DVS), secondary audio programs (SAP) sub channels, weather or traffic sub channels, auxiliary audio/video sub channels, or access to metadata or programming guide sub channels.

4. The method of claim 1 further comprising:
applying a copy protection or content control signal to the one or multiple demodulated RF signals.

5. The method of claim 1 including recording simultaneously one or multiple RF signals.

6. Apparatus for recording and subsequently playing back one or multiple RF signals containing one or more programs, comprising:
a recorder for recording the one or multiple RF signals;
wherein the recorder is enabled to playback the recorded one or multiple RF signals; and
a tuner-demodulator for selectively recovering the one or multiple RF signals to view or distribute the one or more programs contained in the one or multiple RF signals.

7. The apparatus of claim 6 further comprising:
a down-translator for translating the one or multiple RF signals to a lower (intermediate) frequency spectrum;
an amplifier/filter for providing the frequency translated spectrum;
wherein the recorder records the lower frequency translated spectrum; and
an up-translator for translating the lower frequency spectrum back to one or multiple RF signals prior to selectively tuning and demodulating the RF signals.

8. The apparatus of claim 6 further comprising:
an analog to digital converter for digitizing the one or multiple RF signals prior to recording; and
a digital to analog converter for converting the recorded signals, upon playback, to an analog (RF) format.

9. The apparatus of claim 6 wherein the RF signals comprise video and or audio channels including sub channels of descriptive video services (DVS), secondary audio programs (SAP), auxiliary audio/video (material), weather or traffic sub channels, and or access to metadata or programming guide information.

10. The apparatus of claim 6 wherein the recorder simultaneously records the frequency spectrum of the one or multiple RF signals.

11. A system of recording and subsequently playing back a RF signal containing multiple programs, comprising:
a recorder for simultaneously recording a RF signal of the multiple programs;
wherein the recorder plays back the recorded RF signal; and
a tuner and demodulator for tuning and demodulating the played back RF frequency spectrum to extract one or multiple channels and or one or multiple sub channels of the multiple programs.

12. The system of claim 11 wherein recording the RF signal includes circuitry for frequency translation of the RF signal prior to recording, or storing in a memory system.

13. The system of claim 12 wherein the circuitry for frequency translation is provided by sub-Nyquist sampling in an analog to digital converter.

14. The system of claim 12 wherein the circuitry for frequency translation is provided by a mixer or multiplier and a local oscillator.

15. The system of claim 11 further including frequency translation of the played back recorded RF frequency spectrum.

16. The system of claim 11 wherein the RF signal is provided via WiFi, WiMax, IPTV, ATSC, off the air, cable, and or satellite.

17. The system of claim 11 wherein the multiple programs include programs in SDTV and or HDTV.

18. The system of claim 11 wherein the multiple programs include audio programs.

19. The system of claim 11 wherein the tuner and demodulator include one or multiple tuners and or demodulators.

20. The system of claim 19 wherein the one or multiple tuners and or demodulators provide video, audio, data, and or metadata signals simultaneously.
